(19) United States
(12) Patent Application Publication
(10) Pub. No.: US 2014/0245893 A1
(43) Pub. Date: Sep. 4, 2014

(54) METHODS, APPARATUS AND PRODUCTS FOR GRINDING BREWABLE MATERIALS INTO A FILTER CARTRIDGE

(71) Applicant: ROBERT BAO VU, Houston, TX (US)

(72) Inventor: ROBERT BAO VU, Houston, TX (US)

(21) Appl. No.: 13/783,286

(22) Filed: Mar. 2, 2013

(51) Int. Cl. A47J 31/42

(52) U.S. Cl. CPC A47J 31/42
USPC 99/286; 99/289 R; 29/401.1

(57) ABSTRACT

Grinding methods and systems for filling single serve filter cups. A slideably removable cartridge securely holds a single serve filter cup in place to allow the grinder discharge to fill the single serve filter cup. Conversions of grinders to allow filling of single serve filter cups is provided by interchanging the usual grinder discharge bin with the removable cartridge filter holder.

### BACKGROUND OF THE INVENTION

1. Field of the Invention

The present invention relates to apparatus and products for making consumable liquids, and methods of making and using such apparatus, products and liquids. In another aspect, the present invention relates to apparatus and products for brewing such consumable liquids, and methods of making and using such apparatus, products and consumable liquids. In even another aspect, the present invention relates to methods, apparatus and products for filling or loading cartridges for use in brewing such consumable liquids. In still another aspect, the present invention relates to methods apparatus and products for grinding brewable materials into a filter cartridge to be used in a brewing system. In yet another aspect, the present invention relates to methods, apparatus and products for modifying certain grinders to fill single serve filter cups.

2. Description of the Related Art

Single cup brewing systems allow for the brewing of a single cup of a brewed beverage such as coffee, tea, or hot chocolate. Generally, a single-serving unit will contain sufficient ground coffee, tea or other beverage material to produce a single cup of the contained beverage. In operation, this single-serving unit is inserted into a machine, with a cup placed under a discharge spout, and within a short period of time, the beverage is ready.

Generally, this type of single serving brewing machine operates by piercing the single serving container with a spray nozzle, while simultaneously piercing the container with a discharge nozzle. The coffee grounds sit on a filter within the container, which filter is not punctured. The spray nozzle introduces water into the container, with the water passing through the grounds and through the filter into the waiting cup.

Currently, the vast majority of cups/pods that will be purchased and utilized in single serve brewing systems are single use cups/pods, which, as are used once in the brewing process and then discarded. The criticism of these single disposable cups/pods is two-fold. First, there is an environmental concern of placing billions of these disposable cups/pods into the waste stream. Second, the cost of buying coffee in these disposable cups/pods is multiples of what such coffee costs in bulk form.

As a result, recent market developments have includes reusable cups/pods that are re-filled by the consumer. Thus, the environmental issue is addressed as the reusable nature means there are no cups/pods to place into the waste stream. The cost issue is also addressed, as the consumer will purchase the coffee in bulk and re-fill the reusable cup/pod with this bulk purchased coffee.

However, the resistance to these re-fillable single serve filter containers includes at least the step of re-filling the containers. Suddenly, the convenience offered by the pre-packaged disposable single use containers is reduced when the user has to re-fill the reusable cup/pod. One of the hurdles of using a reusable filter is the loading of the reusable filter with coffee. The inventor believes that this refilling of the reusable single serve filters is the major reason that consumers prefer to use the prepackaged disposable single serve coffee cups/pods.

There are a number of patents and patent applications that relate to brewing of coffee, and the single serve brewing of coffee, including at least the following.

U.S. Pat. No. 5,325,765, issued Jul. 5, 1994, and U.S. Pat. No. 5,840,189 issued Nov. 24, 1998, both to Sylvan, et al., disclose a beverage filter cartridge that includes an impermeable pierceable base having a predetermined shape and an opening at one end; a self-supporting wettable filter element disposed in the base sealingly engages with the opening in the base and has a form different and smaller than the predetermined shape of the base so that the filter element diverges from the base and divides the base into two sealed chambers, a first chamber for storing an extract of the beverage to be made, and a second empty chamber for accessing the beverage after the beverage outflow from the filter has been made by combining a liquid with the extract; and an impermeable pierceable cover sealingly engaged with the opening in the base to form an impermeable cartridge.

U.S. Pat. No. 6,589,577 issued to Lazaris, et al. on Jul. 8, 2003, discloses a disposable single serve beverage filter cartridge that includes an outer container with a bottom, and front, back and side walls extending upwardly from the bottom to a peripheral rim surrounding an upper opening. The side wall is contoured to define interior ledges located above the bottom and extending between the front and back walls. A planar filter element having front, back and side edge regions is configured, dimensioned and positioned to subdivide the interior of the container into first and second chambers, with the front and back edge regions of the filter element secured respectively to the front and back walls of the container, and with side edge regions of the filter element secured to respective interior ledges of the container side walls. A beverage medium is stored in the first chamber. A cover is joined to the container rim to close the upper opening. The cover is yieldably piercable to accommodate an inflow of liquid into the first chamber for combination with the beverage medium to produce a beverage. The filter element is permeable to accommodate passage of the beverage from the first chamber into the second chamber, and the container bottom is yieldably piercable to accommodate an outflow of the beverage from the second chamber to the exterior of the cartridge.

U.S. Pat. No. 6,607,762 issued to Lazaris, et al. on Aug. 19, 2003, discloses a disposable single serve beverage filter cartridge that comprises an outer container with an access opening. A filter element is received in and configured and arranged to subdivide the interior of the container into first and second chambers. A beverage medium is stored in the first chamber. A lid closes the access opening. The lid has a first section overlying the first chamber and a second section overlying the second chamber. The first section of the lid is yieldably piercable to accommodate an inflow of liquid into the first chamber for infusion with the beverage medium to produce a beverage. The filter element is permeable to accommodate a flow of the beverage from the first chamber into the second chamber, and the second section of the lid is yieldably piercable to accommodate an outflow of the beverage from the second chamber to the exterior of the cartridge.

U.S. Pat. No. 6,655,260 issued to Lazaris, et al. on Dec. 2, 2003, discloses a beverage filter cartridge holder. A brewer operates during a brew cycle to brew a beverage by infusing heated liquid with a dry beverage medium contained in a single serve disposable cartridge. During the brew cycle, the cartridge is contained in a cup-shaped housing closed by a lid. Rotation of the cartridge within the housing is resisted by locating surfaces arranged to interengage with at least one surface irregularity in the cartridge sidewall. Inlet and outlet probes pierce the cartridge and serve, respectively, to admit the heated liquid and to remove the served beverage.

U.S. Pat. No. 6,658,989 issued to Sweeney, et al. on Dec. 9, 2003, discloses a re-usable beverage filter cartridge for use in a single serve beverage brewer in which a measured charge of a dry beverage medium is infused with a metered amount of heated liquid to produce a beverage medium. This reusable beverage filter cartridge is provided for containing the beverage medium and for accommodating an inflow of the heated liquid and an outflow of the beverage medium. The cartridge comprises a cup-shaped housing having a top opening and a closed bottom with an outlet port. A filter internally subdivides the housing into a first chamber accessible via the top opening and configured and dimensioned to contain the beverage medium, and a second chamber communicating with the outlet port. A lid is removably secured to the housing in a position closing the top opening, and an inlet port in the lid serves to admit heated liquid into the first chamber for infusion with the beverage medium contained therein. The filter is permeable to accommodate a flow there through of the resulting beverage into the second chamber from which it exits via the outlet port.

U.S. Pat. No. 7,165,488 issued Jan. 23, 2007 and U.S. Pat. No. 7,347,138 Mar. 25, 2008, both to Bragg, disclose a brew chamber for a single serve filter package. The chamber includes a receptacle having an open top, configured and dimensioned to receive the package. A frame supports the receptacle for pivotal movement about a first axis between a vertical brew position and a forwardly inclined open position. A lid is supported on the frame for pivotal movement about a second axis between a raised position allowing access to the open top when the receptacle is in the open position, and a lowered position closing the open top when the receptacle is in the brew position. The receptacle is linked to the lid such that the receptacle is pivoted between the brew and open positions in response to movement of the lid between the lowered and raised positions.

U.S. Pat. No. 7,513,192 issued to Sullivan, et al. on Apr. 7, 2009, discloses a beverage forming system includes an actuator and first and second portions that are movable relative to each other between open and closed positions. The first and second portions include a cartridge receiving portion to accept a cartridge for forming a beverage, e.g., a disposable single serve cartridge. A first linkage member may be fixed to the actuator and physically contact a second linkage member that may be fixed to the first or second portion (or to a frame that supports the first and second portions). Movement of the actuator may cause movement of the first and second linkage members relative to each other, thereby causing relative movement of the first and second portions between open and closed positions.

U.S. Pat. No. 7,523,695 issued to Streeter, et al. on Apr. 28, 2009, discloses a system for dispensing a metered volume of heated water to the brew chamber of a single serve beverage dispenser. The system includes: a storage tank for containing a supply of unheated water, a dispensing tank, and a delivery line communicating with the brew chamber and with the dispensing tank at an intermediate level demarcating the interior of the dispensing tank into upper and lower compartments wherein the volume of the upper compartment is equal to the metered volume. The system also includes a vent valve communicating via a vent line with the upper compartment, and a supply line connecting the storage tank to the lower compartment. An air pump is arranged to deliver pressurized air to the upper compartment. A water pump in the supply line is arranged to deliver water from the storage tank to the lower compartment. A heater for heating water is received in the dispensing tank. Sensing means for generating control signals indicative of the level and temperature of water in the dispensing tank; and a controller enabled by control signals generated by the sensing means and operative in response to a brew signal for operating the air and water pumps in conjunction with the opening and closure of the vent valve to fill the upper compartment with heated water displaced the lower compartment and to discharge the thus displaced heated water from the upper compartment to the brew chamber.

U.S. Patent Application Publication No. 20130017303, published Jan. 17, 2013, by Robert Vu, discloses apparatus and products for producing beverages and methods for making and using same. A brewing container for use with brewing machines, the container including a distribution outlet for dispersing the injected water in at least 3 directions away from vertical within the cartridge.

U.S. Pat. No. 8,361,527 issued to Winkler, et al. on Jan. 29, 2013, discloses a method, system and cartridge for forming a beverage includes a cartridge having a container defining an interior space, a lid, a filter, and a beverage medium contained in the interior space. The filter may be attached to the lid only, and extend into the interior space to separate first and second chambers of the cartridge. The filter may hold the beverage medium and be arranged so that, when the lid is removed from the container, e.g., by peeling the lid from the container, the filter and beverage medium are removed together with the lid.

All of the patents cited in this specification, are herein incorporated by reference.

However, in spite of the above advancements the art does not address that need of refilling the single serve reusable filters. Thus, there exists a need in the art for methods, apparatus and products for filling and re-filling these reusable single serve filters with ground coffee.

These and other needs in the art will become apparent to those of skill in the art upon review of this specification, including its drawings and claims.

### SUMMARY OF THE INVENTION

It is an object of the present invention to provide for methods, apparatus and products relating to brewing coffee and other beverages.

It is another object of the present invention to provide for methods, apparatus and products for filling and re-filling these reusable single serve filters with coffee or other brewable beverage.

This and other objects of the present invention will become apparent to those of skill in the art upon review of this specification, including its drawings and claims.

### SUMMARY OF THE INVENTION

According to one embodiment of the present invention, there is provided a grinder system that may include a grinder, may further includes a hopper for receiving beverage media for grinding, the hopper positioned to feed the media to the grinder, and, may even further include a single serve filter holder for receiving a single serve filter and position said single serve filter to receive ground media from the grinder, said single serve filter comprising a biased seat for receiving said single serve filter, with said biased seat securing said single serve filter in the seat. In further embodiments the system may further include a single serve filter positioned in said biased, secured into place by the biased seat.

According to another embodiment of the present invention, there is provided a grinder system that may include a grinder, may further include a hopper for receiving beverage media for grinding, the hopper positioned to feed the media to the grinder, and may further include a single serve filter removeably attached to the system and positioned to receive ground media from the grinder.

According to even another embodiment of the present invention, there is provided a method of modifying a grinder system, the grinder system comprising a grinder, a hopper for receiving beverage media for grinding, the hopper positioned to feed the media to the grinder, and a discharge bin for collecting ground coffee as it is discharged from the grinder. This method may include removing the discharge bin from the grinder system, and the method may further include replacing the discharge bin with a single serve filter holder for receiving a single serve filter and position said single serve filter to receive ground media from the grinder.

According to still another embodiment of the present invention, there is provided a single serve filter holder that may include a frame defining a chute with a chute entrance for receiving ground beverage media and a chute exit for discharging ground beverage media into a single serve filter, and may further include a seat for a single serve filter, the seat positioned to hold the single serve filter in position to receive discharged ground beverage media from the chute exit. In further embodiments, the holder may also include a bias system that secures the single serve filter in the seat.

According to yet another embodiment of the present invention, there is provided a single serve filter system that may include a frame defining a chute with a chute entrance for receiving ground beverage media and a chute exit for discharging ground beverage media into a single serve filter, may further include a seat for a single serve filter, the seat positioned to hold the single serve filter in position to receive discharged ground beverage media from the chute exit, and may further include a single serve filter positioned in the seat. In further embodiments, the system may include a bias system that secures the single serve filter in the seat.

These and other embodiments of the present invention will become apparent to those of skill in the art upon review of this specification, including its drawings and claims.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is an illustration showing a single serve fillable cup 40 and single serve loading system 100 including coffee bean hopper 11, motor/grinder housing 21, Control/electronics housing 18, and loading cartridge 24.

FIG. 2 is an illustration showing the next step in the filling process, with single serve fillable cup 40 now positioned in loading cartridge 24. While loading cartridge is shown removed from loading system 100, is should be understood that single serve fillable cup 40 may be positioned in loading cartridge 24 with such cartridge 24 removed from system 100 or positioned in system 100, at the convenience/choice of the user.

FIG. 3 is an illustration showing the next step in the filling process, with coffee beans being ground and those grounds being loaded into single serve fillable cup 40.

FIG. 4 is an illustration showing the next step in the filling process, with single serve fillable cup 40, filled with coffee, removed from loading cartridge 24, with lid 41 in place and single serve fillable cup 40 ready for user in a single serve brewing machine.

FIG. 5 is an illustration of grinder 70 that is very similar to the grinder of FIGS. 1-4, except that this grinder 70, includes a discharge bin 29 for collecting ground coffee as it is discharged from the grinder.

### DETAILED DESCRIPTION OF THE INVENTION

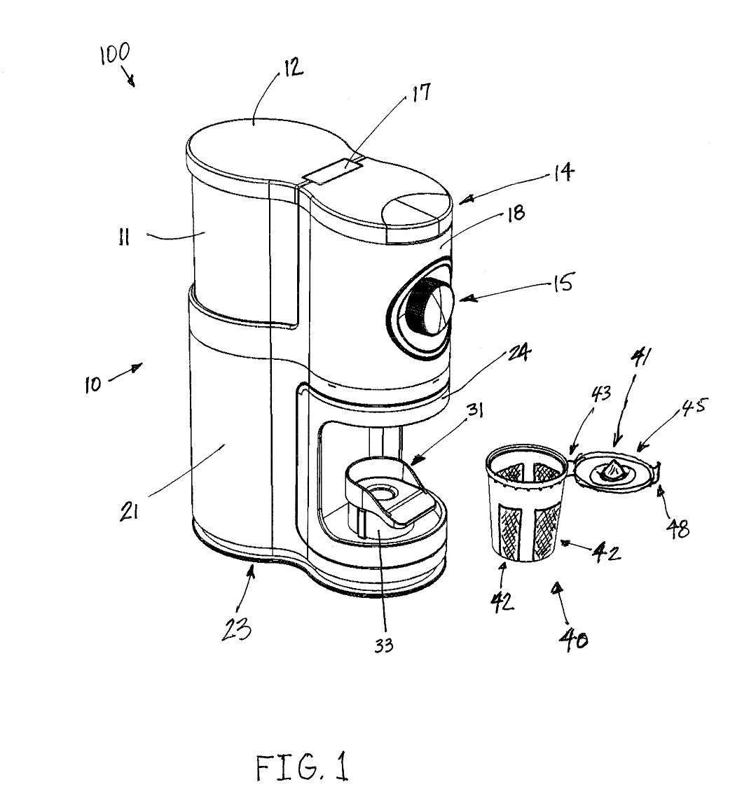

Referring now to FIGS. 1-4 there is shown single serve loading system 100 of the present invention. Single serve loading system 100 includes grinder assembly 10 (inside of housing 21) having coffee bean hopper 11, motor/grinder housing 21, Control/electronics housing 18, and loading cartridge 24.

These FIGS. 1-4 show sequentially, the filling of single serve fillable cup 40 with coffee.

FIG. 1 is an illustration showing a single serve fillable cup 40 and single serve loading system 100 including coffee bean hopper 11, motor/grinder housing 21, Control/electronics housing 18, and loading cartridge 24.

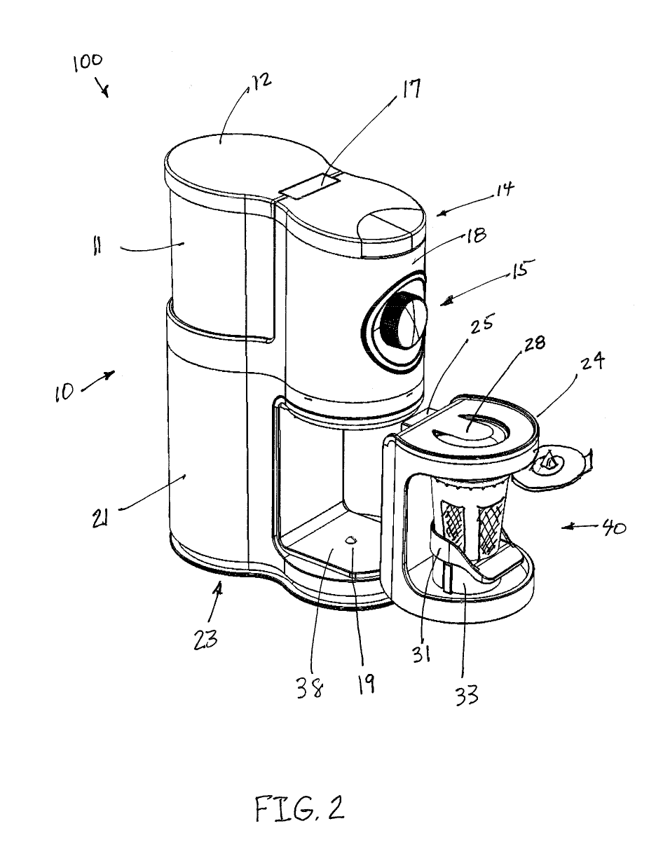

FIG. 2 is an illustration showing the next step in the filling process, with single serve fillable cup 40 now positioned in loading cartridge 24. While loading cartridge is shown removed from loading system 100, is should be understood that single serve fillable cup 40 may be positioned in loading cartridge 24 with such cartridge 24 removed from system 100 or positioned in system 100, at the convenience/choice of the user.

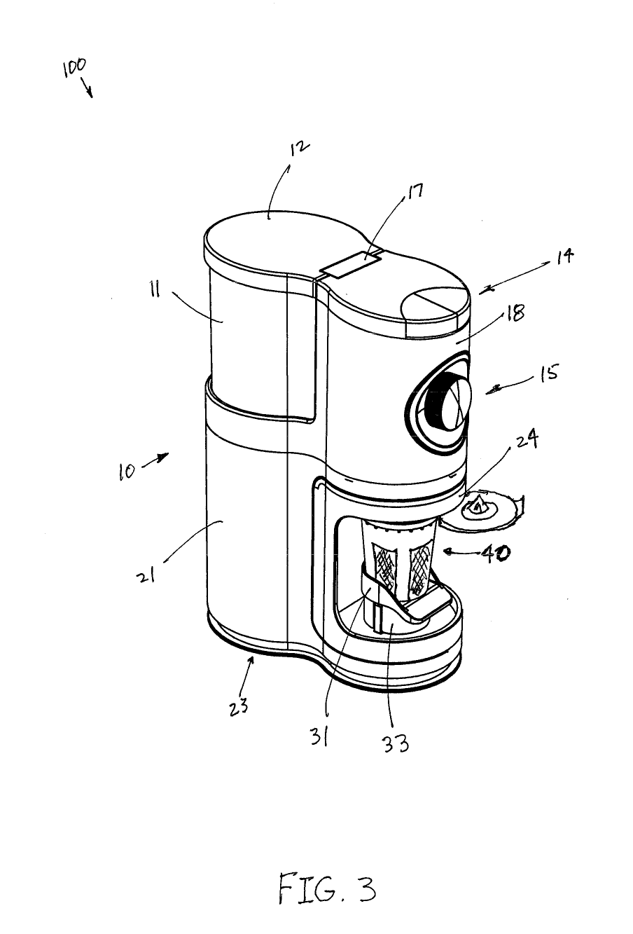

FIG. 3 is an illustration showing the next step in the filling process, with coffee beans being ground and those grounds being loaded into single serve fillable cup 40.

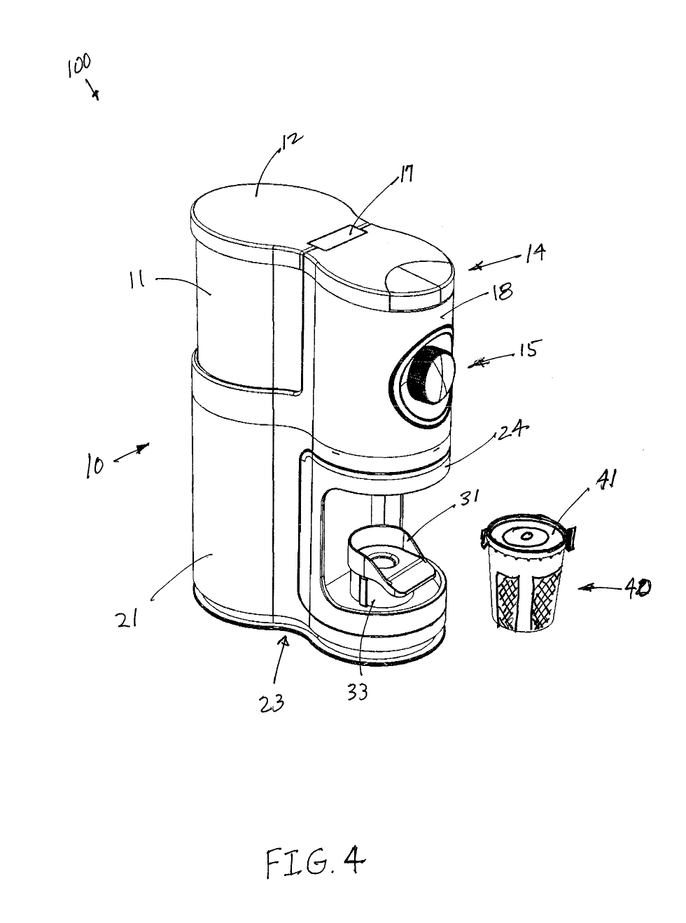

FIG. 4 is an illustration showing the next step in the filling process, with single serve fillable cup 40, filled with coffee, removed from loading cartridge 24, with lid 41 in place and single serve fillable cup 40 ready for user in a single serve brewing machine.

Coffee bean hopper 11 is accessed by opening lid 12 pivotally attached at hinge assembly 17. Coffee bean hopper 11 may be clear or translucent to allow for viewing of the level of coffee beans contained therein. Hopper 11 may be removable to allow for ease of cleaning, and/or the quick change out of one hopper having one kind of coffee with another hopper having a different kind of coffee.

Motor/grinder housing 21 contains the motor assembly and the grinder. It should be understood that the present invention is not directed to any particular type of motor assembly nor grinder and any suitable may be utilized in the present invention. The non-limiting embodiment as shown will utilize a stainless steel grinding plate and gear-type grinding. Base 23 is concave on the bottom and houses the power cord for the motor/grinder. Alternatively, the motor/grinder may be battery powered, most conveniently, the motor/grinder will be driven by an AC power source. A setting switch for incrementally adjusting the grind from “fine” to “coarse” is on the back side of motor/grinder housing 21 out of view.

On opening in the bottom of coffee bean hopper 11 allows for gravity feed of the hopper contents into motor/grinder housing 21 where the beans will come into contact with the grinding surfaces. A setting switch for incrementally adjusting the grind from “fine” to “coarse” is on the back side of motor/grinder housing 21 out of view.

Electronics housing 18 contains the necessary electronics, switches, controls to operate the motor/grinder, including on/off switches 14, and timer 15 to set the length of the grinding time. In some embodiments of the present invention, electronic safety features may be prevent the grinder from operating when not fully assembled, i.e., unless hopper 11 is in place, lid 12 closed, and grinding blades in place.

In the embodiment as shown, loading cartridge 24 is slideably removeable from loading cartridge seat 38, while it is also contemplated in other embodiments that loading cartridge is permanently affixed. The main reason for allowing removal of loading cartridge 24 is ease of cleaning. As shown, loading cartridge 24 is slideably positioned in loading cartridge seat 38, and it urged to remain in place by spring loaded roller ball 19 which ball 19 engages a mating recess in the bottom of loading cartridge 24. Loading cartridge 24 further includes single serve filter seat 31, that is biased to resist movement toward seat base 33. In the embodiment as shown, a spring is positioned between seat 31 and base 33. In order to receive a single serve filter 40, seat 31 may be pushed toward base 33 against the spring to provide room to position single serve filter 40 on seat 31. The spring urges seat 31 upward and impinges the top of single serve filter 40 firmly against distributor 28. Chute 25 receives ground coffee expelled from the grinding occurring in motor/grinder housing 21. Chute 25 provides this ground coffee to distributor 28 that drops this ground coffee into the waiting single serve filter 40.

The present invention contemplates use of disposable or reusable single serve filters. In the embodiment as shown, single serve filter cup 40 includes filter elements 42, lid 41 connected by hinge 43, clasp 48, and liquid distributor 45.

In operation, coffee beans (or other brewing medium) are placed in hopper 11 and lid 12 closed. A grind setting from fine to coarse is selected, and timer 15 is set to a desired grinding time. A single serve fillable cup 40 is placed in loading cartridge 24. On switch 14 (left) is pressed and the grinding proceeds. Should it be desired to stop the grinding for any reason, off switch 14 (right) would be pressed. As the grinding proceeds coffee grounds are expelled into chute 25 with distributor 28 dropping the grounds into single serve filter 40. Subsequently, a full single use fillable cup 40 is removed and ready for use in a single serve brewing machine.

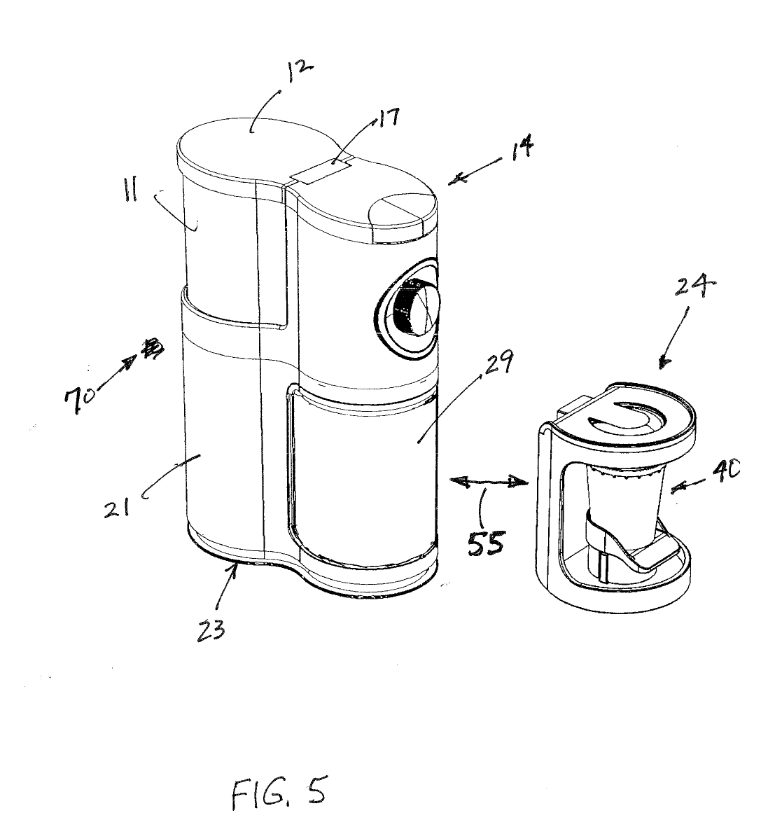

The present invention also provided methods, apparatus and products for modifying certain grinders to fill single serve filter cups. Referring now to FIG. 5, there is shown a grinder 70 that is very similar to the grinder of FIGS. 1-4, except that this grinder 70, includes a discharge bin 29 for collecting ground coffee as it is discharged from the grinder. This discharge bin 29 is slideably removeable from grinder 70 and has a lid for access to the ground contents. This discharge bin also have a chute/opening for receiving ground coffee discharged from the grinder. The problem with the discharge bin is that ground coffee must now to transferred to a filter system, or to a single serve filter cup. Interchangeable with this discharge bin 29 is loading cartridge 24 (see arrow 55). Grinder 70 may easily be modified by removing discharge bin 29 and replacing it with loading cartridge 24, thereby modifying grinder 70 into a single serve filter filling system.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A grinder system comprising
(A) A grinder;
(B) A hopper for receiving beverage media for grinding, the hopper positioned to feed the media to the grinder; and,
(C) A single serve filter holder for receiving a single serve filter and position said single serve filter to receive ground media from the grinder, said single serve filter comprising a biased seat for receiving said single serve filter, with said biased seat securing said single serve filter in the seat.

2. The grinder system of claim 1, further comprising:
(D) A single serve filter positioned in said biased, secured into place by the biased seat.

3. The grinder system of claim 2, wherein the seat is biased by a spring.

4. The grinder system of claim 2, wherein the single serve filter is reusable.

5. The grinder system of claim 2, wherein the single serve filter is disposable.

6. A grinder system comprising
(A) A grinder;
(B) A hopper for receiving beverage media for grinding, the hopper positioned to feed the media to the grinder; and,
(C) A single serve filter removeably attached to the system and positioned to receive ground media from the grinder.

7. The grinder system of claim 6, further comprising a bias system for securing the single serve filter while still allowing it to be removeably attached.

8. The grinder system of claim 7, wherein the bias system comprises a spring.

9. The grinder system of claim 6, wherein the single serve filter is reusable.

10. The grinder system of claim 6, wherein the single serve filter is disposable.

11. A method of modifying a grinder system, the grinder system comprising a grinder, a hopper for receiving beverage media for grinding, the hopper positioned to feed the media to the grinder, and a discharge bin for collecting ground coffee as it is discharged from the grinder, the method comprising:
(A) Removing the discharge bin from the grinder system; and,
(B) Replacing the discharge bin with a single serve filter holder for receiving a single serve filter and position said single serve filter to receive ground media from the grinder.

12. The method of claim 11, further comprising (C) positioning a single serve filter in the holder.

13. A method of modifying a grinder system, the grinder system comprising a grinder, a hopper for receiving beverage media for grinding, the hopper positioned to feed the media to the grinder, and a discharge bin for collecting ground coffee as it is discharged from the grinder, the method comprising:
(A) Removing the discharge bin from the grinder system; and,
(B) Replacing the discharge bin with a single serve filter, said filter positioned to receive ground media from the grinder.

14. A single serve filter holder comprising:
(A) a frame defining a chute with a chute entrance for receiving ground beverage media and a chute exit for discharging ground beverage media into a single serve filter; and,
(B) a seat for a single serve filter, the seat positioned to hold the single serve filter in position to receive discharged ground beverage media from the chute exit.

15. The single serve filter holder of claim 14, further comprising (C) a bias system that secures the single serve filter in the seat.

16. The single serve filter holder of claim 15, wherein the bias system comprises a spring.

17. A single serve filter system comprising:
(A) a frame defining a chute with a chute entrance for receiving ground beverage media and a chute exit for discharging ground beverage media into a single serve filter;
(B) a seat for a single serve filter, the seat positioned to hold the single serve filter in position to receive discharged ground beverage media from the chute exit; and,
(C) a single serve filter positioned in the seat.

18. The system of claim 17, further comprising:
(D) a bias system that secures the single serve filter in the seat.

19. The single serve filter holder of claim 18, wherein the bias system comprises a spring.
